(19) United States
(12) Patent Application Publication
(10) Pub. No.: US 2019/0059446 A1
(43) Pub. Date: Feb. 28, 2019

(54) VAPORIZER UNIT FOR AN INHALER AND METHOD FOR CONTROLLING A VAPORIZER UNIT

(71) Applicant: HAUNI MASCHINENBAU GMBH, HAMBURG (DE)

(72) Inventors: MARC KESSLER, HAMBURG (DE); GUNNAR NIEBUHR, HAMBURG (DE); RENE SCHMIDT, BUCHHOLZ i.d.N. (DE)

(21) Appl. No.: 16/111,913

(22) Filed: Aug. 24, 2018

(30) Foreign Application Priority Data
Aug. 25, 2017 (DE) 10 2017 119 521.1

(51) Int. Cl. A24F 47/00; H05B 1/02

(52) U.S. Cl. CPC A24F 47/008; H05B 1/0297

(57) ABSTRACT

A vaporizer unit for an inhaler, the vaporizer unit incorporating an electronic control device and at least one heating element, where the vaporizer unit is configured to vaporize a liquid fed from a liquid reservoir, such that the vaporized liquid is received by an air stream flowing through the vaporizer unit. The electronic control device is configured to heat the at least one heating element with a corresponding at least one control frequency, wherein: one or more control frequencies of the at least one control frequency is a variable control frequency; two or more control frequencies of the at least one control frequency are different control frequencies; or one or more control frequencies of the at least one control frequency is a variable control frequency and two or more control frequencies of the at least one control frequency are different control frequencies.

### CROSS REFERENCE TO A RELATED APPLICATION

This application claims priority under 35 U.S.C. § 119(e) of German Patent Application No. DE 10 2017 119 521.1, filed Aug. 25, 2017, which is incorporated herein by reference in its entirety.

### FIELD OF THE INVENTION

The present invention refers to a vaporizer unit for an inhaler comprising an electronic control device and at least one heating element, wherein the vaporizer unit is adapted for vaporizing a liquid fed by a liquid reservoir, and the vaporized liquid is received by the air stream flowing through the vaporizer unit.

### BACKGROUND OF THE INVENTION

The majority of the vaporizer units currently available in the market is provided in an electronic cigarette product and is based on the so-called wick-coil principle. A wick, such as of fiberglass, is partially surrounded by a heating coil and is connected to a liquid reservoir. When the heating coil is heated, the liquid disposed in the wick vaporizes in the region of the heating coil. The liquid is typically a mixture of various substances, which have different boiling temperatures and different physiological effects. In order to control the effect, the droplet size is adjusted, since different droplet sizes are reabsorbed by the body with different speeds. The use of a suitable electronic control device allows a precise adjustment of the droplet size of the droplets present in the resulting aerosol by adjusting the heating temperature of the heating element which is provided in the form of a heating coil. Such an electronic cigarette is described in US 2016/0021930 A1 (R.J. Reynolds Tobacco Company), for example.

Due to the different boiling temperatures of the substances present in the liquid, a substance having a low boiling temperature may be completely consumed after a corresponding usage time, without the liquid reservoir being emptied. Thus during the consumption, the physiologic or tasted effect of the resulting aerosol varies. If nicotine is exhausted, for example, then the smoking experience may be hampered.

Moreover, due to the uncontrolled temperature increase, an undesired partial heating and overheating of the liquid or of a substance contained therein may take place, thus causing an undesired emission of pollutants.

### BRIEF DESCRIPTION OF THE INVENTION

The object of the invention is to provide a safe, high-quality and energy-efficient vaporizer unit, in which a reliable administration of active ingredients is provided and wherein a potential risk of overheating and of correlated emission of pollutants may be avoided.

The invention achieves this object by means of the characteristics of independent claims. It is proposed that the electronic control device is adapted for heating the heating element with a variable control frequency.

It has been demonstrated that, besides the geometry and the suitably adapted liquid feeding, the control frequency with which the at least one heating element is heated has a decisive impact on the size of the droplets in the aerosol. The quantity of vapor generated while pulsing or otherwise heating at different frequencies may be adjusted in a different and thus precise way and also the droplet size of the aerosol varies considerably according to the vapor quantity depending on the geometry of the heating element used. A high control frequency facilitates the generation of smaller droplets, while a lower control frequency causes the generation of larger droplets. According to the invention, the absorption and action of the substances present in the liquid are set through the droplet size by means of the control frequency. Moreover the heating temperature may be set according to the substances in the liquid and an overheating may be avoided. Also it has been demonstrated that the energy consumption of the vaporizer is improved by adjusting the droplet size through the frequency with respect to the setting of the temperature.

The inventive heating at a variable control frequency allows the formation of droplets having a variable size and thus a variable action. The term “variable control frequency” encompasses the temporal and/or spatial variation of the control frequency. By means of a temporally variable control, for example, the administration of physiologic active ingredients may be controlled and the nicotine supply during smoking may be set in such a way that the smoking enjoyment is improved.

In a preferred embodiment, the electronic control device is adapted for heating the at least one heating element with a plurality of different control frequencies, in order to achieve a multimodal droplet size distribution. The heating of the at least one heating element having the plurality of different control frequencies means that a plurality of control frequencies may be overlapped and thus the at least one heating element may be heated simultaneously with a plurality of frequencies. A plurality of frequencies may be applied globally or at specific positions of the least one heating element, so that the at least one heating element is subdivided in different regions having different control frequencies.

The vaporizer unit preferably has a plurality of heating elements and the electronic control device is adapted for heating different heating elements at different control frequencies. By controlling different heating elements at different control frequencies different droplet sizes may be provided simultaneously. Each heating element may generate for example one or more droplet sizes, which together are received by the air stream flowing through the vaporizer unit and are fed to the user.

The electronic control device is advantageously adapted for controlling the control frequency of the plurality of heating elements in such a way that a multimodal droplet size distribution of the vaporized liquid is obtained. If a plurality of heating elements is controlled, in parallel, at different frequencies, a multimodal adjustable droplet size distribution may be achieved. If, for example, the generation of large droplets, such as >5 μm, and small droplets, such as <1 μm, is required, the heating elements may be controlled in such a way that at least one of the heating elements generates large droplets and at least one of the heating elements generates small droplets. Preferably, to this end, the at least one heating element for the small droplets is heated at a high control frequency while the at least one heating element for large droplets is heated at a low control frequency. Further heating elements may also be added, in order to generate droplets having a specific size.

The resulting droplet size distribution is multimodal and has maxima at the desired droplet sizes. This facilitates a positive smoking experience, for example, since small droplets penetrate deep into the airways, where nicotine and other substances are effective, while large droplets may be perceived as good tasting. The precise adjustment of the multimodal distribution corresponds to a precise adjustment of the physiologic and tasting effects. A 1:1 ratio of small to large droplets may be conceived, in order to provide a fast (small droplets) and a prolonged effect (large droplets).

In a preferred embodiment the electronic control device is adapted for varying the control frequency of the at least one heating element over the emptying time of the liquid reservoir. During the emptying of the liquid reservoir the concentrations of the substances in the liquid may vary due to their different boiling temperature and/or volatility. The liquid contained in the liquid reservoir segregates due to the differential distillation occurring during evaporation. This means that higher boiling components are enriched causing an inhomogeneous emission of active ingredients. For example, starting from a half used liquid reservoir, the quantity of nicotine is significantly lower. A desired physiologic effect of the active ingredients of the individual substances may preferably be obtained by varying the control frequency over the duration of emptying of the liquid reservoir.

The electronic control device is adapted for increasing the control frequency of the at least one heating element according to a progressive emptying of the liquid reservoir. Nicotine evaporates, for example, at a relatively low temperature. Thus, during the emptying of the liquid reservoir, the dose of nicotine inhaled for each breath decreases while temperature and droplet size remain constant. Due to the adaptation of the droplets, such as by providing large droplets at the beginning (delayed effect in the body) and small droplets at the end (fast action) of the emptying time interval of the liquid reservoir, the subjective experience may be homogenized and the concentration variations are equalized. In order to facilitate a positive experience for the smoker, it is proposed that the control frequency is increased during emptying of the liquid reservoir, and that smaller droplets are produced, in order to maintain a constant smoking experience.

It is advantageous if the control frequency of the at least one heating element is varied during a breath. The physiologic and taste-related effect may be positively influenced during a breath, if the control frequency and thus the droplet size is adjusted.

Preferably, the control frequency of the at least one heating element may be precisely adjusted, in such a way that a desired droplet size of the evaporated liquid is obtained, such as ≤5 μm. Droplets having a diameter or an aerodynamic diameter (mass median aerodynamic diameter—MMAD) of less than 5 μm do not remain in the upper airways, but penetrate into the bronchia, facilitating a resorption of nicotine or other active ingredients, for example, for medical treatments. The aerodynamic diameter is the diameter at which the entirety of particles having a smaller or larger diameter contribute half of the total mass of all particles. In particularly preferred embodiments the droplet size is smaller than 0.2 μm. These very small droplets having an MMAD or diameter of less than 1 μm penetrate into the alveola and pass through the blood-brain-barrier very fast. The effect may thus be anticipated or delayed according to the droplet size. By adjusting the droplet size the action time may thus be influenced.

In a preferred embodiment, the control frequency of the at least one heating element is set at at least 10 Hz and preferably at a maximum of 20 kHz. The inventive variable control frequencies in a preferred example are within a range from 10 Hz to 20 kHz, in particular between 500 Hz and 2 kHz. The frequencies may be adjusted individually for each heating element in each heater. Thus a preferred distribution of droplet sizes and an energy-efficient heating may be facilitated.

It is advantageous if the resistance of the at least one heating element is measured. If the heating element is a thermistor, then the temperature may be determined through a resistance measurement. A diagnosis of the operating status, of the state of the heating element wetted with the liquid (wrong liquid, no liquid, not enough liquid, the correct liquid quantity and/or too much liquid) and/or of possible faulty functions may be performed. In a preferred embodiment, the control and measurement device comprises a data processing unit or is connected thereto.

The control and measurement device is advantageously provided with a reference resistor, which is series-connected to the heating element. Each heating element is preferably series-connected to a separate reference resistor. This allows a precise measurement of the resistance of the heating element or of the heating elements.

The control and measurement device is preferably provided with at least one operational amplifier. An operational amplifier may amplify the current flowing through the heating element, and may provide a simple evaluation through the data processing unit.

In a preferred embodiment, the control and measurement device is provided with a switching device. The switching device may activate the control and measurement device, if no heating voltage is applied on the heating element (subsequent phase) and deactivate it, if a heating voltage is applied on the heating element (heating or vaporizing phase). A measurement may however also occur during a heating pulse in the vaporizing phase. The measurement results of the switching device are preferably processed in the preferably shared data processing unit.

Based on the measurement values, one or more of the following measures are preferably implemented:

status check, monitoring and/or fault detection of the vaporizer unit;

control or regulation of the vaporizer unit with a corresponding time scale;

determination of the temperature of the at least one heating element.

The electronic control device may be adapted for performing said measures based on the measurement values, such as checking, regulating, controlling or further measuring.

The at least one heating element is preferably a microelectromechanical unit. A microelectromechanical unit (MEMS) preferably has a very low thermal capacity and/or a high thermal conductance. Thus the heating element is provided with a lower thermal inertia and may rapidly vary its temperature and cause a particularly rapid evaporation. A rapid temperature variation is particularly preferred in the case of high control frequencies and allows the production of particularly small droplets.

The invention is explained in the following by means of preferred embodiments with reference to the appended figures. In particular

### BRIEF DESCRIPTION OF THE FIGURES

FIG. 1 shows a schematic structure of an inhaler;

FIGS. 2, 3 show a circuit diagram for a preferred embodiment of the inhaler;

FIG. 4 shows an example of the temporal evolution of the heating voltage; and

FIG. 5 shows an example of the temporal evolution of the control frequency.

### DETAILED DESCRIPTION

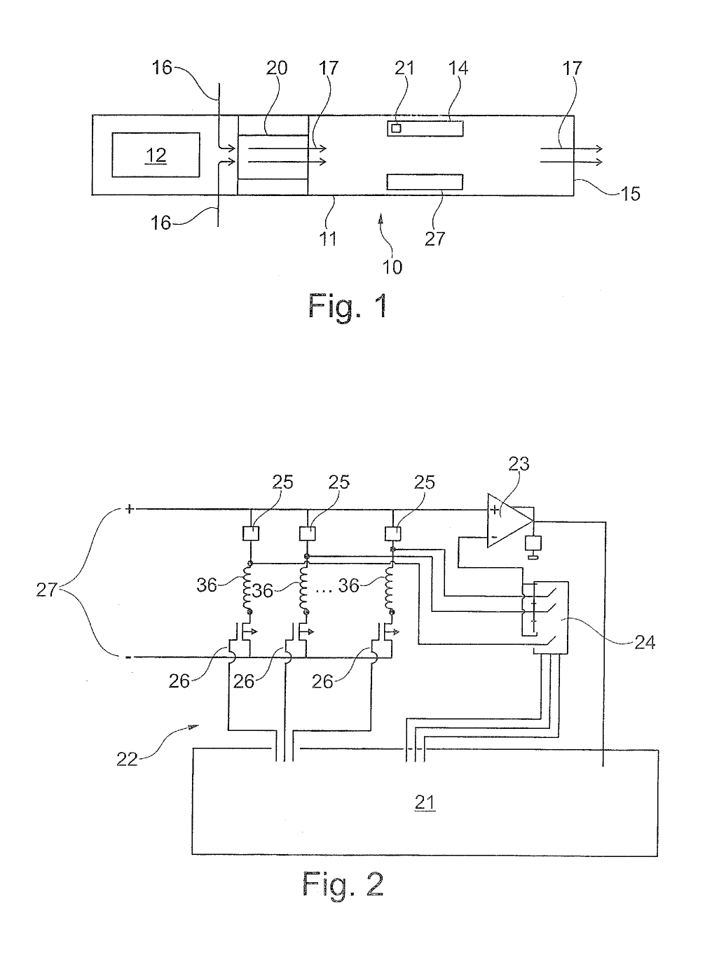

FIG. 1 shows the schematic structure of an inhaler 10, such as an electronic cigarette product. The inhaler comprises a housing 11, which has an essentially rod-like or cylindrical shape and which is provided with a mouth end 15 and one or more air intake openings 16. The mouth end 15 defines the end, at which the user inhales. Between the mouth end 15 and the air intake openings 16 an air channel is provided, through which an air stream 17 may pass. If the user inhales at the mouth end 15, then the inhaler 10 is subject to a vacuum, so that an air stream 17 is generated within the air channel between the air intake openings 16 and the mouth end 15. The air intake openings 16 may be positioned on the lateral side of the housing 11. In addition or as an alternative, at least one air intake opening 16 may be provided at the end of the inhaler 10, which is opposed with respect to the mouth end 15.

The air stream 17 passes through a vaporizer unit 20 which is positioned in the housing 11. The vaporizer unit 20 is supplied with a liquid from a liquid reservoir 12, and is provided with at least one heating element 36. The inhaler 10 comprises the liquid reservoir 12, which contains the liquid to be vaporized. A suitable volume of the liquid reservoir 12 is in the range from 0.1 to 5 ml, preferably between 0.5 and 3 ml, further preferably between 0.7 and 2 ml or 1.5 ml. the liquid reservoir 12 preferably has a closed surface and is preferably a flexible bag. The liquid supply is advantageously obtained through the vaporized liquid quantity.

The vaporizer unit 20 is supplied with a liquid from the liquid reservoir 12 and is electrically controlled in order to vaporize the liquid and to feed the same as a gas and/or aerosol to the air stream 17. The vaporizer unit 20 is positioned in an axial heating portion within the housing 11.

The quantity of the aerosol generated within the vaporizer unit 20 may be varied both through variation of the applied electrical voltage and through the number of heating elements 36 which operate in parallel. An electrical voltage may be applied to the heating elements 36 for example in the form of pulses, oscillations or by means of a pulse width modulation. A characteristic of the voltage, such as the amplitude and/or the frequency spectrum, may advantageously be adjusted over time or set by the user of the inhaler 10.

The inhaler 10 comprises an electronic unit 14, which is connected to a current source 27 and which may perform a measurement, control, regulation, data processing and/or data transfer. The electronic unit 14 comprises, to this end, preferably an electronic control device 21, in particular a microprocessor or microcontroller. The electronic unit 14 may preferably comprise an interface, which is adapted for providing data to the user of the inhaler 10 or for allowing data input by the user of the inhaler 10. A smoker may for example select their favorite settings over a smartphone and Bluetooth connectivity and share these settings on a social network, as well as provide recommendations and statistically evaluate their data and their user behavior. The data preferably comprise data related to the at least one heating element 36, control frequencies, the filling level of the liquid reservoir 12, the current source 27 and/or diagnostic and error data. The regulation of the control frequencies by means of a regulation element positioned on the housing 11, such as a switch or an adjustment wheel, may also be conceived.

The current source 27 may be an electrochemical disposable battery or a rechargeable electrochemical accumulator, such as a Li-Ion accumulator or a lithium battery. Based on a lithium battery having a voltage of 2.7-4.1 V, by means of a step-up converter, variable voltages up to 43 V, preferably of 5-15 V, particularly preferably of 2.7-15 V, and even more preferably of 3.6-6 V may be generated, which are adapted to the heating elements 36. The current source 27 provides the electric power supply of all active electric components within the inhaler 10.

The inhaler 10 is preferably modular and subdivided in at least one disposable unit and at least one reusable unit. The vaporizer unit 20 may be a replaceable cartridge or part of such a cartridge. The base body of the inhaler 10 may be reusable. The electronic unit 14 and/or the current source 27 are preferably connected through an interface with the vaporizer unit 20. The current source 27 and/or the liquid reservoir 12 may be positioned within a disposable unit and may be disposable in nature or may be positioned for a repeated use within a reusable unit within the housing 11.

The vaporizer unit 20 may be used in electronic cigarette products as well as in medical inhalers. Besides the use in rod-like electronic cigarette products, the vaporizer unit 20 may be used for example in electronic pipes, shishas, or other products, in which a liquid from a liquid reservoir 12 has to be vaporized.

FIG. 2 shows a circuit diagram for a preferred embodiment of the inhaler 10 with three heating elements 36, as an example. In other embodiments, not shown, the number of heating elements 36 is higher or lower than three.

The inhaler 10 comprises a control and measurement device 22, which is advantageously powered with electric current by the electronic unit 14 through the current source 27. The control and measurement device 22 is controlled by the electronic control device 21. The control and measurement device 22 comprises an operational amplifier 23, a switching device 24, at least one reference resistor 25 and at least one transistor 26. A reference resistor 25 (shunt) and a transistor 26 are preferably both series-connected to each heating element 36. In a preferred embodiment, the electronic unit 14 is provided with the operational amplifier 23, the switching device 24, the one or more reference resistors 25 and/or the one or more transistors 26.

The electronic control device 21 is adapted for detecting a breath performed by a consumer by means of a suitable sensor, such as a pressure sensor, and based thereon, for controlling the heating elements 36 in the vaporizer unit 20, in order to heat up the liquid to a suitable temperature.

The electronic control device 21 is connected with the transistors 26 and may control them independently from each other, in order to independently control the heating elements 36 corresponding to transistors 26. The electronic control device 21 is connected with the switching device 24 and the operational amplifier 23 as shown in FIG. 2, in order to perform measurements of the resistance of the heating elements 36. Further sensors for measuring temperatures, pressures and other values describing the operational status may be comprised within the control and measurement device 22 and may be connected to the electronic control device 21.

The operational amplifier 23 (current shunt monitor) is connected to the control device 21, to a mass, a positive pole, the reference resistor 25 and to the switching device 24 and provides, for example, the measurement of the voltage drops between one of the reference resistors 25 and the voltage source 27. An amplified measurement result is forwarded by the operational amplifier 23 to the control device 21, where the data processing occurs, in order to determine the measured resistance of the corresponding heating element 36.

The switching device 24 is controlled by the control device 21 and preferably defines one of the reference resistors 25 as the reference resistor 25 to be measured. An electrical connection is preferably provided with the switching device 24 between the heating element 36 and the corresponding reference resistor 25. The switching device 24 is preferably provided with a switch for each reference resistor 25 to be measured, in order to perform precise measurements.

The reference resistors 25 (shunts) are preferably ohmic resistors. Each heating element 36 is provided with a reference resistor 25 for current measurements.

The transistors 26 are preferably field effect transistors (FET) and are used for controlling and regulating the heating elements 36. Each heating element 36 may be controlled through a corresponding transistor 26.

By using a suitable circuit, besides the individual control of heating elements 36, also check mechanisms may be incorporated. In this way a monitoring and checking of the vaporizer unit 20 may be performed. Measurements may occur at switching on, switching off and/or during inhaling, however when the heating voltage is deactivated, such as every 10-1000 ms for each channel, preferably 20-500 ms, in particular every 250-400 ms. By multiplexing and modulating the signals on a carrier signal, the data quantity may be reduced.

The current data obtained by the individual heating elements 36 correlate with their resistance. The resistance is univocally correlated to the temperature of the respective heating element 36 through the known NTC or PTC behavior. Besides the monitoring of the structures, resistance and temperature information may be used for controlling and regulating the heating elements 36. A detailed fault detection allows the detection of, for example, incorrect, insufficient or excessive liquid quantities or of a faulty heating element 36; a precise status detection based on the known thermodynamic state and the composition of the liquid is possible.

Moreover, further sensors may be comprised within the inhaler 10, preferably a thermometer, a moisture and/or pressure sensor, in order to precisely characterize the operating state of the vaporizer 20 and/or of the heating elements 36.

Preferably, the heating elements 36 are ohmic resistances and formed in a microelectromechanical unit (such as a MEMS). The embodiment as a microelectromechanical unit is particularly advantageous due to its very fine structures in the μm-range and the corresponding thermal properties. The microelectromechanical heating elements 36 are preferably made of a semiconductor material, such as doped silicon. This is inert and has a catalytic effect and the heating element 36 may thus be produced in a small size, in a reproducible and stable way. Through doping, a temperature-dependent resistance of 0.1-20 Ohm, preferably 0.5-1.5 Ohm may be set, for example. Depending on the doping, a temperature-dependent NTC or PTC behavior of the resistance of the heating elements 36 may be obtained, i.e. the resistance drops or increases when the temperature increases.

The heating elements 36 are connected to the liquid reservoir 12. The liquid is fed into a pore structure of the heating elements 36, by capillarity, for example. If the heating elements 36 are heated to a temperature above the boiling temperature of a component of the liquid, then an evaporation on the surface of the heating elements 36 occurs. The structure and the surface of the heating elements 36 may also be based on bionic structures, such as trachea. Through a reticulated heating structure of the heating elements a capillary barrier may be formed with respect to air on one side and with respect to liquid on the other side. The heating structures are positioned along the delimiting surface between air and liquid and when reaching the boiling temperature, the vaporized liquid may penetrate through the heating structure and may be supplied to the air stream 17.

The heating elements 36 preferably each have a layered structure, wherein a respective heating element 36 has a preferred surface of 0.25-6 mm², in particular preferably of 0.5-3 mm². The surface of all heating elements 36 in total is preferably of 0.2-1 cm², in particular preferably of 0.3-0.8 cm², and a preferred layer thickness is in the range of 3-400 μm, in order to obtain an optimal relationship with the liquid volume to be vaporized depending on the heating surface. The pores of the heating structure have a diameter between 10 and 100 μm for example and preferably between 15 and 50 μm.

The embodiment of the heating elements 36 as microelectromechanical units allows a variation of the vapor quantity at constant average (vaporizing) performance by varying the control frequency. This allows a particularly efficient and energy-efficient vapor generation by the heating elements 36. If the heating element 36 is controlled, i.e. heated, with a certain frequency, then the percentage of the heating power provided to the vaporization is increased to an optimum while keeping an average heating power, when increasing the frequency. Thus, at higher frequencies higher vapor quantities are to be expected, since the resulting vaporizing effect is increased. The optimization of the energy supply also causes a reduced current consumption.

Besides the frequency-dependent influence over the vapor quantity, a variation of the aerosol quality depending on the control frequency of the heating elements 36 may be observed. When increasing the control frequency, a finer droplet size distribution may be observed, i.e. the distribution of the droplet size shifts in favor of a smaller droplet size. This is caused by an improved heat transmission into the vaporizing liquid, at higher frequencies. A suitable pulse or a sufficient frequency are chosen, in order for the heat of the heating element 36 to transfer to the liquid without causing losses due to an excessively rapid energy transmission at an excessive frequency (short pulse duration) or due to an excessively rapid cooling at too low frequencies (long pulse duration). This influence over the vapor is particularly advantageous when the heating elements 36 are formed by a microelectromechanical unit and are able to follow the fast change in energy transmission with their heat surface temperature, i.e. when they are provided with a small thermal inertia. In contrast to a coil or grid structure, the heating elements 36 are provided with a considerably higher limit frequency.

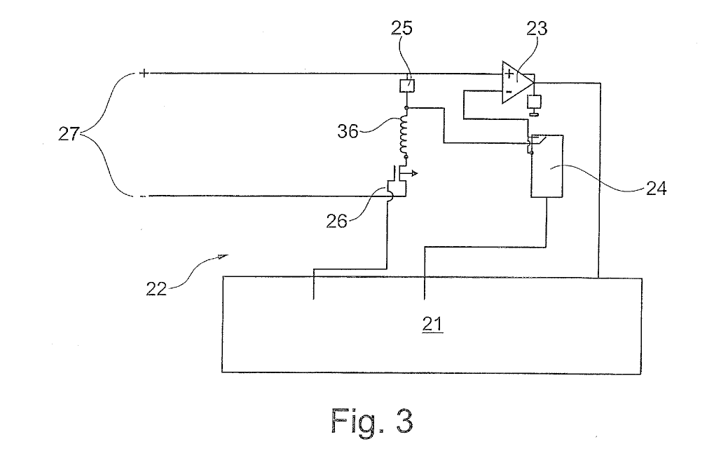

FIG. 3 shows a circuit diagram for a preferred embodiment of the inhaler 10 with a heating element 36, as an example.

The inhaler 10 comprises a control and measurement device 22, which is advantageously comprised of the electronic unit 14 and which is supplied with electric current by the current source 27. The control and measurement device 22 is controlled by the control device 21. The control and measurement device 22 comprises an operational amplifier 23, a switching device 24, a reference resistor 25 and a transistor 26. The heating element 36 is preferably provided with a series-connected reference resistor 25 and a transistor 26, which is also series-connected thereto. In an embodiment, not shown, the switching device 24 may be omitted in case of only one heating element 36, in order to provide a simpler and more cost-effective structure.

In this embodiment having only one heating element 36, the heating element 36 may be subject to various and variable control frequencies. Both a superposition of different control signals and a temporal variation and/or modulation may be conceived, in order to obtain a desired droplet size distribution.

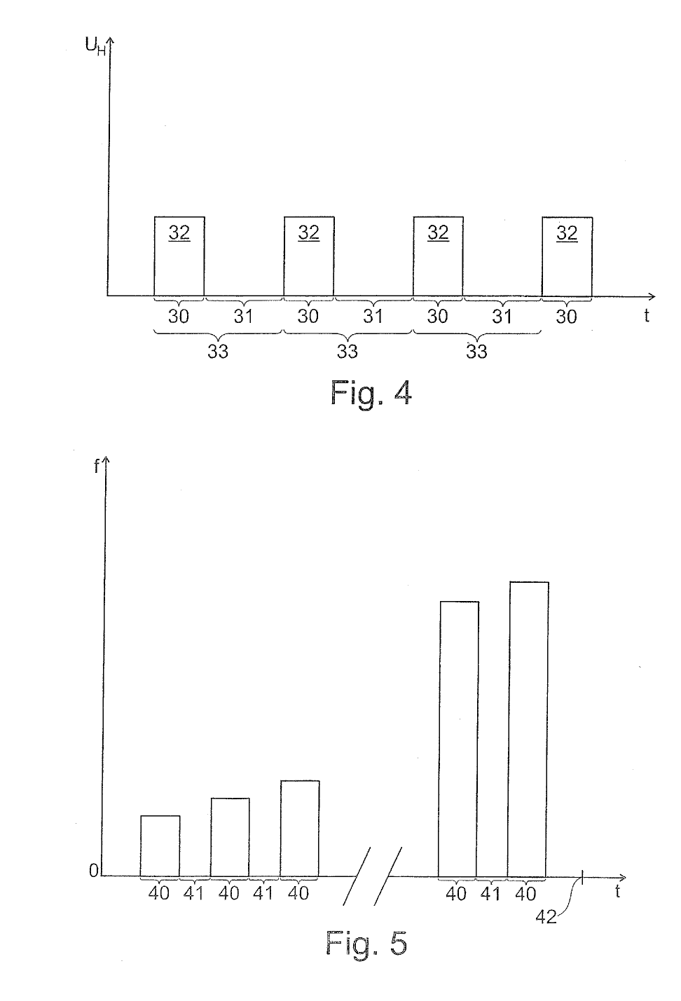

FIG. 4 shows an example of the temporal evolution of the heating voltage U_{H} applied to the heating element 36. The heating element 36 in this embodiment is heated with pulses 32 depending on time t. A period 33 is divided in a vaporizing phase 30 and a subsequent phase 31. In the vaporizing phases 30, a heating voltage U_{H} is applied to the heating element 36 and allows the vaporization of the liquid present on and/or at the heating element 36. During the subsequent phase 31, no heating voltage is applied to the heating element 36. During a period 33 a vaporizing phase 30 takes place, the length of which is defined by the scan degree. For example, during a period duration 33 and/or a shorter fraction of a period duration 33, different heating elements 36 may be measured sequentially. With a suitable period duration 33, also a plurality of measurements, regulations, controls and/or checks may be performed on various heating elements 36. In a preferred embodiment, measurements are performed at regular intervals, in order to simplify the control, regulation, monitoring and/or data processing.

The heating power supply may also be conceived in other forms, such as by alternating currents, periodical and aperiodic evolutions. The overlapping of periodic signals with different frequencies or periods 33 is advantageous and allows the generation of differently sized droplets. The period 33 in a preferred embodiment varies over the duration of operation and/or is preferably adjustable. Each heating element 36 may be heated in the same way or in different ways.

FIG. 5 shows an example of the temporal evolution of the control frequency f, which is applied onto the heating element 36. The control frequency f increases over time t in the duration 42. The duration 42 may be determined, for example, by the emptying duration of the liquid reservoir 12. The dashed time axis shows that the emptying duration in this example should not be limited to the number of five breaths 10 as shown. In this example, the control frequency f is constant during a breath 40. The heating power to the heating element 36 follows the profile shown in FIG. 4 for a breath. The individual breaths 40 are interrupted by pauses 41, in which a measurement, control, regulation and/or monitoring of the operational state may be performed. From breath 40 to breath 40, over time t, the control frequency f increases and allows, in the course of time t, the generation of ever smaller droplets, in order to homogenize the smoking experience and the nicotine consumption, for example. Depending on the application, other temporal evolutions of the frequency may be conceived.

### Embodiments

1. A vaporizer unit (20) for an inhaler (10), comprising an electronic control device (21) and at least one heating element (36), wherein the vaporizer unit (20) is adapted for vaporizing a liquid fed from a liquid reservoir (12) and the vaporized liquid is received by an air stream flowing through the vaporizer unit (20),

characterized in that

the electronic control device (21) is adapted for heating the at least one heating element (36) with a variable control frequency.

2. The vaporizer unit (20) according to Embodiment 1, characterized in that the electronic control device (21) is adapted for heating the at least one heating element (36) with a plurality of different control frequencies.

3. The vaporizer unit (20) of any of the preceding Embodiments, characterized in that the vaporizer unit (20) has a plurality of heating elements (36), and the electronic control device (21) is adapted for heating various heating elements (36) with different control frequencies.

4. The vaporizer unit (20) of Embodiment 3, characterized in that the electronic control device (21) is adapted for controlling the control frequency of the plurality of heating elements (36) in such a way that a multimodal droplet size distribution of the vaporized liquid is obtained.

5. The vaporizer unit (20) of any of the preceding Embodiments, characterized in that the electronic control device (21) is adapted for varying the control frequency of the at least one heating element (36) over the emptying duration of the liquid reservoir (12).

6. The vaporizer unit (20) of Embodiment 5, characterized in that the electronic control device (21) is adapted for increasing the control frequency of the at least one heating element (36) while the liquid reservoir (12) is progressively emptied.

7. The vaporizer unit (20) of any of the preceding Embodiments, characterized in that the electronic control device (21) is adapted for varying the control frequency of the at least one heating element (36) over the course of one breath.

8. The vaporizer unit (20) of any of the preceding Embodiments, characterized in that the electronic control device (21) is adapted for setting the control frequency of the at least one heating element (36) in such a way that a desired droplet size of the evaporated liquid of ≤5 μm is obtained, for example.

9. The vaporizer unit (20) of any of the preceding Embodiments, characterized in that the electronic control device (21) is adapted for setting the control frequency of the at least one heating element (36) at at least 10 Hz and preferably at most at 20 kHz.

10. The vaporizer unit (20) of any of the preceding Embodiments, characterized in that a control and measurement device (22) is provided, which is adapted for measuring the resistance of the at least one heating element (36).

11. The vaporizer unit (20) of Embodiment 10, characterized in that the control and measurement device (22) is provided with at least one reference resistor (25), which is series-connected with the at least one heating element (36).

12. The vaporizer unit (20) of Embodiments 10 or 11, characterized in that the control and measurement device (22) is provided with at least one operational amplifier (23).

13. The vaporizer unit (20) of any of Embodiments 10 to 12, characterized in that the control and measurement device (22) is provided with at least one switching device (24).

14. The vaporizer unit (20) of any of Embodiments 10 to 13, characterized in that, based on the measured values of the control and measurement device (22), one or more of the following measures are implemented:

status check, monitoring and/or fault detection of the vaporizer unit (20);

control or regulation of the vaporizer unit (20);

determination of the temperature of the at least one heating element.

15. The vaporizer unit (20) of any of the preceding Embodiments, characterized in that the at least one heating element (36) is a microelectromechanical unit.

16. A method for controlling a vaporizer unit (20) for an inhaler (10) having an electronic control device (21) and at least one heating element (36), wherein the vaporizer unit (20) is adapted for vaporizing a liquid fed from a liquid reservoir (12), and wherein the vaporized liquid is received by an air stream flowing through the vaporizer unit (20),

characterized in that

the electronic control device (21) heats the at least one heating element (36) with a variable control frequency.

1. A vaporizer unit for an inhaler, comprising:
an electronic control device; and
at least one heating element,
wherein the vaporizer unit is configured to vaporize a liquid fed from a liquid reservoir to produce a vaporized liquid, such that the vaporized liquid is received by an air stream flowing through the vaporizer unit,
wherein the electronic control device is configured to heat the at least one heating element with a corresponding at least one control frequency, and
wherein:
one or more control frequencies of the at least one control frequency is a variable control frequency;
two or more control frequencies of the at least one control frequency are different control frequencies; or
one or more control frequencies of the at least one control frequency is a variable control frequency and two or more control frequencies of the at least one control frequency are different control frequencies.

2. The vaporizer unit of claim 1,
wherein one or more control frequencies of the at least one control frequency is a variable control frequency.

3. The vaporizer unit of claim 1,
wherein two or more control frequencies of the at least one control frequency are different control frequencies.

4. The vaporizer unit according to claim 1,
wherein the at least one heating element is a plurality of heating elements,
wherein the electronic control device is configured to heat the plurality of heating elements with a corresponding plurality of control frequencies, and
wherein two or more control frequencies of the plurality of control frequencies are different control frequencies.

5. The vaporizer unit of claim 4,
wherein the electronic control device is configured to control the plurality of control frequencies of the plurality of heating elements in such a way that a multimodal droplet size distribution of the vaporized liquid is obtained.

6. The vaporizer unit according to claim 1,
wherein the electronic control device is configured to vary the at least one control frequency of the at least one heating element over an emptying duration of the liquid reservoir.

7. The vaporizer unit of claim 6,
wherein the electronic control device is configured to increase the at least one control frequency of the at least one heating element while the liquid reservoir is progressively emptied.

8. The vaporizer unit according to claim 1,
wherein the electronic control device is configured to vary the at least one control frequency of the at least one heating element over a course of one breath.

9. The vaporizer unit according to claim 1,
wherein the electronic control device is configured to set the at least one control frequency of the at least one heating element in such a way that a desired droplet size of the vaporized liquid of ≤5 μm is obtained.

10. The vaporizer unit according to claim 1,
wherein the electronic control device is configured to set the at least one control frequency of the at least one heating element at greater than or equal to 10 Hz.

11. The vaporizer unit according to claim 10,
wherein the electronic control device is configured to set the at least one control frequency of the at least one heating element at less than or equal to 20 kHz.

12. The vaporizer unit according to claim 1, further comprising:
a control and measurement device,
wherein control and measurement device is configured to measure a corresponding at least one resistance of the at least one heating element.

13. The vaporizer unit of claim 12,
wherein the control and measurement device is provided with a corresponding at least one reference resistor, which is series-connected with the at least one heating element.

14. The vaporizer unit of claim 12,
wherein the control and measurement device is provided with at least one operational amplifier.

15. The vaporizer unit according to claim 12,
wherein the control and measurement device is provided with at least one switching device.

16. The vaporizer unit according to claim 12,
wherein the vaporizer unit is configured to, based on measured values of the control and measurement device, implement one or more of the following:
a status check of the vaporizer unit;
monitoring of the vaporizer unit;
fault detection of the vaporizer unit;
control or regulation of the vaporizer unit; and
a determination of a corresponding at least one temperature of the at least one heating element.

17. The vaporizer unit according to claim 1,
wherein the at least one heating element is a microelectromechanical unit.

18. A method for controlling a vaporizer unit for an inhaler,
providing a vaporizer unit for an inhaler,
wherein the vaporizer unit comprises:
an electronic control device; and
at least one heating element,
wherein the vaporizer unit is configured to vaporize a liquid fed from a liquid reservoir to produce a vaporized liquid, such that the vaporized liquid is received by an air stream flowing through the vaporizer unit,
wherein the electronic control device is configured to heat the at least one heating element with a corresponding at least one control frequency, and
wherein:
one or more control frequencies of the at least one control frequency is a variable control frequency;
two or more control frequencies of the at least one control frequency are different control frequencies; or
one or more control frequencies of the at least one control frequency is a variable control frequency and two or more control frequencies of the at least one control frequency are different control frequencies; and
vaporizing the liquid fed from the liquid reservoir via the vaporizer unit to produce the vaporized liquid, such that the vaporized liquid is received by the air stream flowing through the vaporizer unit,
wherein vaporizing the liquid fed from the liquid reservoir via the vaporizer unit to produce the vaporized liquid comprises heating the at least one heating element, via the electronic control device, with a corresponding at least one control frequency, and
wherein:
one or more control frequencies of the at least one control frequency is a variable control frequency;
two or more control frequencies of the at least one control frequency are different control frequencies; or
one or more control frequencies of the at least one control frequency is a variable control frequency and two or more control frequencies of the at least one control frequency are different control frequencies.

19. An inhaler, comprising:
a liquid reservoir; and
a vaporizer unit,
wherein the vaporizer unit comprises:
an electronic control device; and
at least one heating element,
wherein the vaporizer unit is configured to vaporize a liquid fed from the liquid reservoir to produce a vaporized liquid, such that the vaporized liquid is received by an air stream flowing through the vaporizer unit,
wherein the electronic control device is configured to heat the at least one heating element with a corresponding at least one control frequency, and
wherein:
one or more control frequencies of the at least one control frequency is a variable control frequency;
two or more control frequencies of the at least one control frequency are different control frequencies; or
one or more control frequencies of the at least one control frequency is a variable control frequency and two or more control frequencies of the at least one control frequency are different control frequencies.
